(19) United States
(12) Patent Application Publication
(10) Pub. No.: US 2025/0348625 A1
(43) Pub. Date: Nov. 13, 2025

(54) CIRCUIT PATTERNS FOR PHYSICALLY UNCLONABLE FUNCTION AND METHOD OF ACHIEVING PHYSICALLY UNCLONABLE FUNCTION THROUGH CIRCUIT PATTERNS

(71) Applicant: United Microelectronics Corp., Hsin-Chu City (TW)

(72) Inventor: Chia-Chen Sun, Kaohsiung City (TW)

(73) Assignee: United Microelectronics Corp., Hsin-chu City (TW)

(21) Appl. No.: 18/751,370

(22) Filed: Jun. 24, 2024

(30) Foreign Application Priority Data
May 9, 2024 (CN) 202410566843.1

(51) Int. Cl. G06F 21/75

(52) U.S. Cl. CPC G06F 21/75

(57) ABSTRACT

A circuit pattern for physically unclonable function (PUF) is provided in the present invention, including a metal spiral pattern composed of multiple horizontal line segments connected with vertical line segments and a dummy metal spiral pattern composed of multiple dummy horizontal line segments connected with dummy vertical line segments, wherein the horizontal line segments and dummy horizontal line segments are adjacent and alternately arranged in a vertical direction, and the vertical line segments and dummy vertical line segments are adjacent and alternately arranged in a horizontal direction.

### BACKGROUND OF THE INVENTION

### 1. Field of the Invention

The present invention relates generally to a circuit pattern for physically unclonable function (PUF), and more specifically, to a PUF pattern with active circuit and dummy circuit at the same time.

### 2. Description of the Prior Art

Internet of things (IoT) technology installs sensors and software on various electronic equipment, so that they may be connected with each other for data transmission, and various aspects and interactive information of real world may therefore be digitalized to collect scattered data and integrate digital information between things, which is a foundation for industrial intellectualization and has very wide application, such as transportation logistics, commercial manufacture, health care, intelligent environment (family, office or factory), personal field and social field.

Nevertheless, the convenience of IoT also brings about higher risk for information security at the same time. Since IoT equipment is involved in a wide field of application, hackers may launch attack in many aspects, which is a tough challenge for security. Speaking of the information security of IoT in the past, most people may anticipate the encrypted connection in software and internet aspects. However, in addition to the safety protection in internet aspect, physical equipment in IoT also encounters the same threat. As long as counterfeit chips or other problem emerges, hacker may remotely control the equipment, acquire key or other sensitive information through internet, and in turn cause a loss for company. Therefore, software-based information security design is no longer sufficient to provide comprehensive security and safeguard in IoT field.

Accordingly, hardware security technology based on physically unclonable function (PUF) emerges, with principle of introducing various random variables in semiconductor process to create slight differences in microscopic structure of IC products. Under the circumstances that these kinds of random variables are unpredictable and uncontrollable, duplication of these chips is almost impossible, thereby reducing the risk of intentional reverse engineering and operation. The properties of randomness, uniqueness and nonreproducibility make PUF a kind of IC fingerprint, and therefore becomes a popular choice in the zero trust architecture of information security in new generation.

### SUMMARY OF THE INVENTION

In the light of strong demand for hardware information security in current internet of things (IoT) technology, the present invention hereby provides a novel circuit pattern, with feature of forming metal spiral pattern and corresponding dummy metal spiral pattern to induce or enhance process variation, so that resistance range read from the metal spiral pattern may be increased, thereby achieving the purpose of enhancing random code generation in physically unclonable function (PUF).

One aspect of the present invention is to provide a circuit pattern for physically unclonable function (PUF), including a PUF cell array, the PUF cell array is comprised of multiple arranged PUF cells, and each PUF cell includes: a metal spiral pattern, including multiple connected horizontal line segments extending in a horizontal direction and multiple connected vertical line segments extending in a vertical direction and with one end connected to a constant voltage and the other end connected to a ground voltage; and a dummy metal spiral pattern, including multiple connected dummy horizontal line segments extending in the horizontal direction and multiple connected dummy vertical line segments extending in the vertical direction and not connected to any voltage, wherein the horizontal line segments and the dummy horizontal line segments are adjacent and alternately arranged in the vertical direction, and the vertical line segments and the dummy vertical line segments are adjacent and alternately arranged in the horizontal direction.

Another aspect of the present invention is to provide a method of achieving physically unclonable function (PUF) through circuit pattern, including: providing a PUF cell array, the PUF cell array is comprised of multiple arranged PUF cells, and each PUF cell includes: a metal spiral pattern, including multiple connected horizontal line segments extending in a horizontal direction and multiple connected vertical line segments extending in a vertical direction and with one end connected to a constant voltage and the other end connected to a ground voltage; and a dummy metal spiral pattern, including multiple connected dummy horizontal line segments extending in the horizontal direction and multiple connected dummy vertical line segments extending in the vertical direction and not connected to any voltage, wherein the horizontal line segments and the dummy horizontal line segments are adjacent and alternately arranged in the vertical direction, and the vertical line segments and the dummy vertical line segments are adjacent and alternately arranged in the horizontal direction; applying a constant voltage to the PUF cell array, wherein the constant voltage is applied on every PUF cell and generates a resistance corresponding to the PUF cell; and determining a random code of the corresponding PUF cell as 0 if the resistance is less than a setting value, and determining a random code of the corresponding PUF cell as 1 if the resistance is greater than a setting value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic plan view of a physically unclonable function (PUF) cell array in accordance with one embodiment of present invention;

FIG. 2 is a schematic top view of a circuit pattern for PUF in accordance with one embodiment of the present invention;

FIG. 3 includes top views and a cross-sectional view of parts of line segments in the circuit pattern for PUF in accordance with one embodiment of present invention;

FIG. 4 includes top views and a cross-sectional view of parts of line segments in the circuit pattern for PUF in accordance with one embodiment of present invention;

FIG. 5 is a top view of parts of line segments in the circuit pattern for PUF in accordance with one embodiment of present invention;

FIG. 6 is a cross-sectional view of parts of line segments in the circuit pattern for PUF in accordance with one embodiment of present invention;

FIG. 7 is a schematic view showing the widen resistance distribution read from the PUF cell in accordance with one embodiment of present invention;

FIG. 8 illustrates inherent random code fingerprints of multiple PUF chips in accordance with one embodiment of the present invention; and

FIG. 9 is a block diagram of a system on a chip (SoC) with PUF block in accordance with one embodiment of present invention.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

It should be readily understood that the meaning of “on,” “above,” and “over” in the present disclosure should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something). Further, spatially relative terms, such as “beneath,” “below,” “lower,” “above,” “upper,” and the like, may be used herein for ease of description to describe one element or feature relationship to another element(s) or feature(s) as illustrated in the figures.

As used herein, the term “layer” refers to a material portion including a region with a thickness. A layer can extend over the entirety of an underlying or overlying structure, or may have an extent less than the extent of an underlying or overlying structure. Further, a layer can be a region of a homogeneous or inhomogeneous continuous structure that has a thickness less than the thickness of the continuous structure. For example, a layer can be located between any pair of horizontal planes between, or at, a top surface and a bottom surface of the continuous structure. A layer can extend horizontally, vertically, and/or along a tapered surface. A substrate can be a layer, can include one or more layers therein, and/or can have one or more layer thereupon, thereabove, and/or therebelow. A layer can include multiple layers. For example, an interconnect layer can include one or more conductor and contact layers (in which contacts, interconnect lines, and/or through holes are formed) and one or more dielectric layers.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Additionally, the term “based on” may be understood as not necessarily intended to convey an exclusive set of factors, but may allow for the presence of other factors not necessarily expressly described, again depending at least in part on the context.

It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The circuit pattern and relevant embodiment provided by the present invention are used to achieve physically unclonable function (PUF) for identifying hardware equipment. This sort of structure may be designed in an application specific integrated circuit (ASIC) or field programmable gate array (FPGA), with principle of establishing challenge/response database when equipment or device is manufactured to identify the equipment without algorithm for authenticated encryption, thereby preventing the theft or tamper of equipment ID as well as waiving additional cost for injecting key to the equipment and preventing later risk of key lost and information security vulnerability.

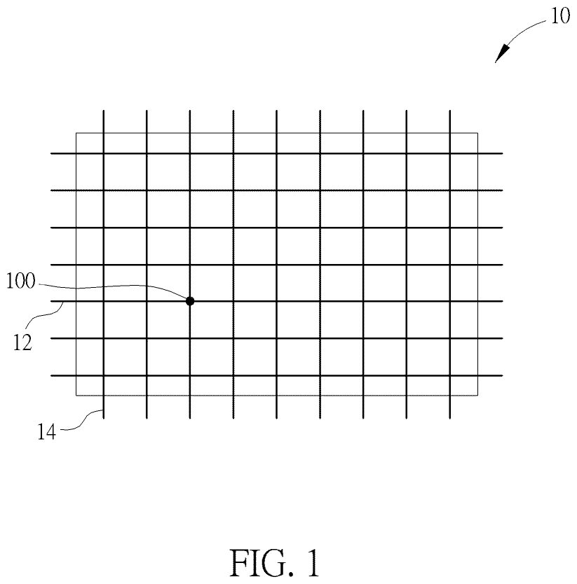

Please refer to FIG. 1, which is a schematic plan view of a physically unclonable function (PUF) cell array in accordance with one embodiment of the present invention. In general, the structure of present invention is a PUF cell array 10 comprised of multiple arranged PUF cells 100. Each PUF cell 100 is located at a node intersecting by an input line 12 and an output line 14 and may be connected with memory devices. In the application of preferred embodiment, current may be inputted to PUF cell array 100 through input line 12, flow through the connected PUF cells 100 and then be outputted through output line 14, so that electric property or characteristics like voltage or resistance of every PUF cell 100 in the PUF cell array 10 may be obtained, and random code like 0 or 1 may be produced therefrom. Accordingly, the PUF cell array 10 comprised of multiple PUF cells 100 is provided with an innate, inherent electrical fingerprint, which may functions as a key for identifying chip or equipment.

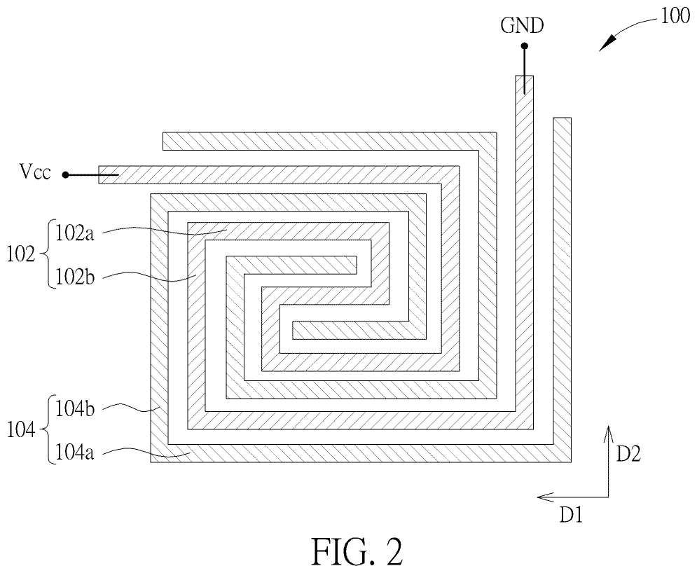

Please refer next to FIG. 2, which is a schematic top view of a PUF cell in accordance with the preferred embodiment of present invention. In the preferred embodiment of present invention, the PUF cell 100 is preferably made of metal circuit in BEOL (back-end-of-line) process, such as conductive circuit pattern in one metal layer in BEOL process. As shown in the figure, in the embodiment, each PUF cell 100 substantially includes a metal spiral pattern 102 and a dummy metal spiral pattern 104, wherein the metal spiral pattern 102 is composed of multiple horizontal line segments 102a extending in a horizontal direction D1 connected with multiple vertical line segments 102b extending in a vertical direction D2. The metal spiral pattern 102 is generally provided with two terminals, with one end connected to a constant voltage Vcc (ex. through the input line 12 in FIG. 1) and the other end connected to a ground voltage GND (ex. through the output line 14 in FIG. 1). The connection may be achieved through vias in BEOL interconnects, so that the resistance of metal spiral pattern 102 may be obtained as a PUF characteristic by measuring the voltage change during PUF operation.

In another aspect, dummy metal spiral pattern 104 is composed of multiple dummy horizontal line segment 104a extending the horizontal direction D1 connected with multiple dummy vertical line segment 104b extending the vertical direction D2. Please note that in the present invention, the dummy metal spiral pattern 104 is a dummy pattern, meaning this pattern would not be connected to any voltage and not involved in the conduction of electrical signal in the circuit. The dummy metal spiral pattern 104 is designed specifically to increase process variation in order to fulfill the purpose of enhancing random coding of PUF cell. As shown in FIG. 2, in the embodiment of present invention, the dummy metal spiral pattern 104 is designedly in an arrangement that its dummy horizontal line segments 104a and the horizontal line segments 102a of metal spiral pattern 102 are adjacent and alternately arranged in the vertical direction D2, while its dummy vertical line segments 104b and the vertical line segments 102b of metal spiral pattern 102 are adjacent and alternately arranged in the horizontal direction D1. With this arrangement, the dummy metal spiral pattern 104 adjacent to metal spiral pattern 102 is likely to induce variation of the metal spiral pattern 102, ex. pattern variation or content variation, thereby altering its electrical performance. Relevant details will be described in following embodiment later.

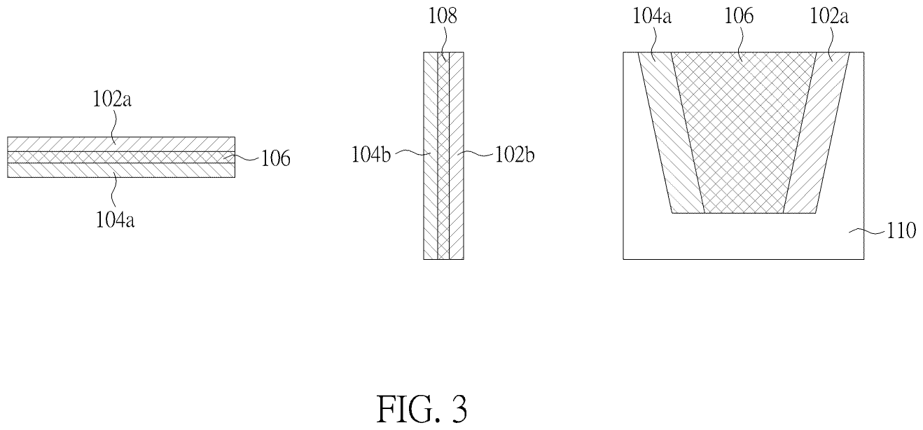

Please refer to FIG. 3, which includes top views and a cross-sectional view of parts of horizontal line segments or vertical line segments in the metal spiral pattern 102 and dummy spiral pattern 104. In the present invention, the presence of dummy metal spiral pattern 104 is likely to induce or enhance various process-based variations. The embodiment of FIG. 3 is one of these exemplifications. As shown in the figure, please note that as far as BEOL metal interconnects are concerned, the metal spiral pattern 102 and dummy spiral pattern 104 of present invention is in the same metal level, both of them are formed in the same inter-metal dielectric (IMD) layer 110. With respect to those processes that the metal spiral pattern 102 and dummy spiral pattern 104 are defined through different photomasks, ex. litho-etch-litho-etch (LELE) double patterning process, parts of dummy horizontal line segments 104a or parts of dummy vertical line segments 104b in the finally-defined photoresist pattern are likely to overlap the horizontal line segments 102a or vertical line segments 102b alternately arranged therewith in adjacent metal spiral pattern 102 due to overlay shift, thereby causing final metal circuit pattern formed by using the photoresist as an etching mask would be far variant from predetermined pattern. Take this embodiment as an example, parts of line segments in the metal spiral pattern 102 and dummy metal spiral pattern 104 that are supposed to be isolated from each other have overlapping portions 106, 108, forming a common line segment with larger width, and the metal spiral pattern 102 and dummy metal spiral pattern 104 are therefore short-circuited. These factors may all significantly alter original resistance of the metal spiral pattern 102.

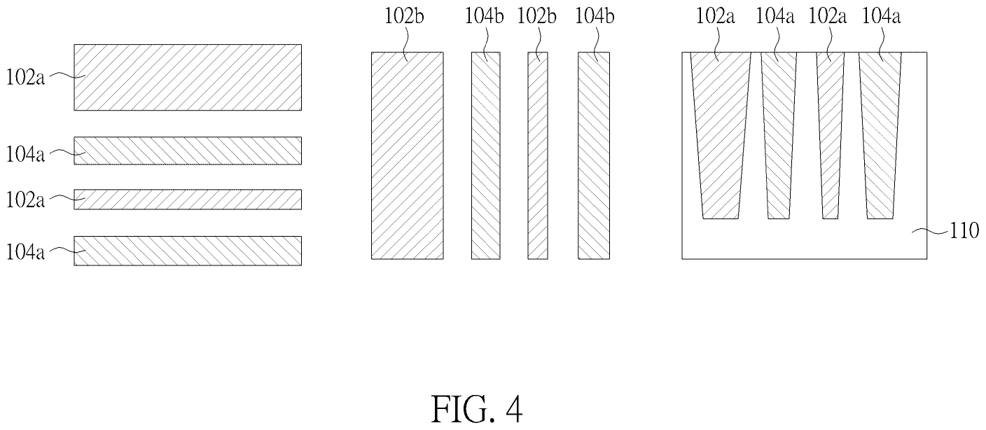

In another aspect, please refer to FIG. 4, which includes top views and a cross-sectional view of parts of horizontal line segments or vertical line segments in the metal spiral pattern 102 and dummy metal spiral pattern 104 in accordance with another embodiment of the present invention. With respect to those processes that the metal spiral pattern 102 and dummy metal spiral pattern 104 are defined using the same photomask, the presence of dummy metal spiral pattern 104 would still enhance pattern variation of the metal spiral pattern 102 formed therein. As shown in FIG. 4, since dummy metal spiral pattern 104 is added adjacent to the metal spiral pattern 102 in original layout, parts of the horizontal line segments 102a and/or vertical line segments 102b may be possibly rendered wider or thinner during the correction process for metal circuit pattern in the stage of optical proximity correction (OPC), especially when line segments of the two patterns are arranged alternately, wider line segment would decrease original resistance of the line segment, while thinner line segment would increase original resistance of the line segment. This is also one of the factors that increase the resistance variation.

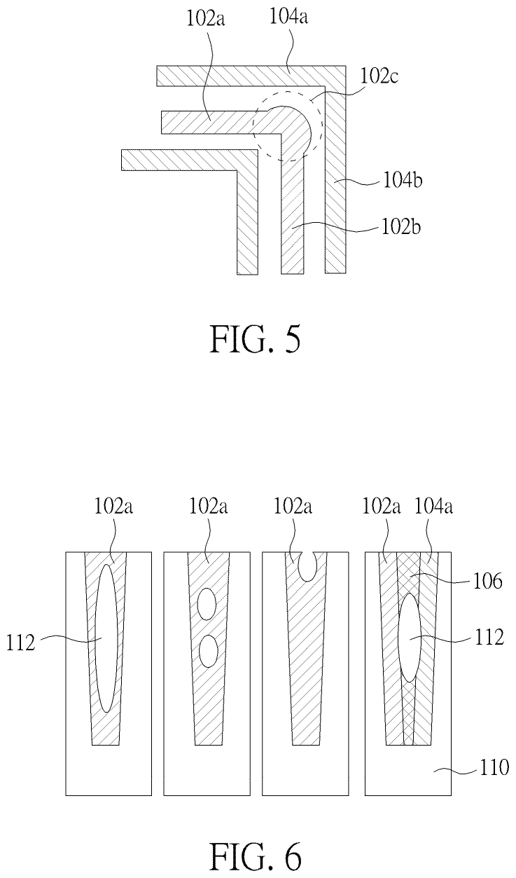

Please refer to FIG. 5, which is a top view of parts of line segments in a circuit pattern for PUF in accordance with another embodiment of the present invention. This embodiment shows another aspect that the presence of dummy metal spiral pattern 104 would enhance pattern variation of the metal spiral pattern 102 in OPC. As shown in the figure, since the metal spiral pattern 102 is composed of multiple horizontal line segments 102a connected with multiple vertical line segments 102b, connecting positions of the horizontal line segment 102a and vertical line segment 102b would form rounding feature 102c. In normal OPC process, these rounding features 102c is likely to be rendered and different from the original pattern, for example form corner rounding feature, in order to prevent the patterns formed at these positions suffer defect or distortion issue in real photolithography process. In this embodiment that the dummy metal spiral pattern 104 exists, the process/correction of OPC for the corner rounding feature 102c would be more significant, rendering the processed pattern more variant from original pattern, thereby enhancing resistance variation of the metal spiral pattern 102 formed therein.

Please refer to FIG. 6, which is a cross-sectional view of parts of line segments in the circuit pattern for PUF. In addition to the aforementioned resistance variation enhanced by overlay shift and OPC process, the presence of dummy metal spiral pattern 104 may also enhance the variation of metal spiral pattern 102 in other process. As shown in FIG. 6, take deposition and filling process of the metal circuit as an example, the dummy metal spiral pattern 104 would change the deposition environment of the metal line (ex. increased pattern density and decreased pattern spacing), so as to result in incomplete deposition, voids 112 may be formed possibly in the horizontal line segment 102a or vertical line segment 102b of metal spiral pattern 102 or in the common line segments formed collectively with the dummy horizontal line segment 104a or dummy vertical 1 line segment 104b. This may significantly alter the predetermined resistance of metal spiral pattern 102 and enhance the variation.

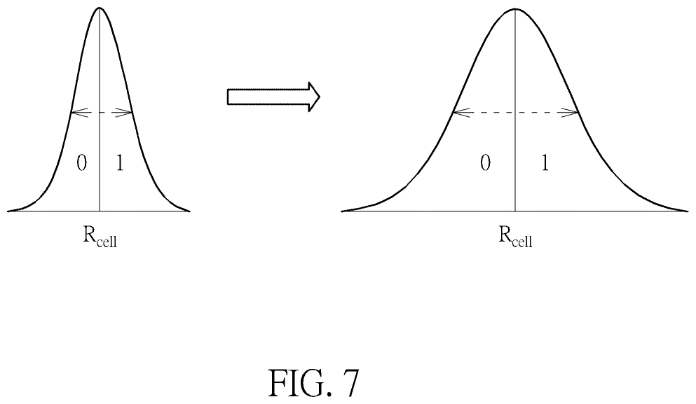

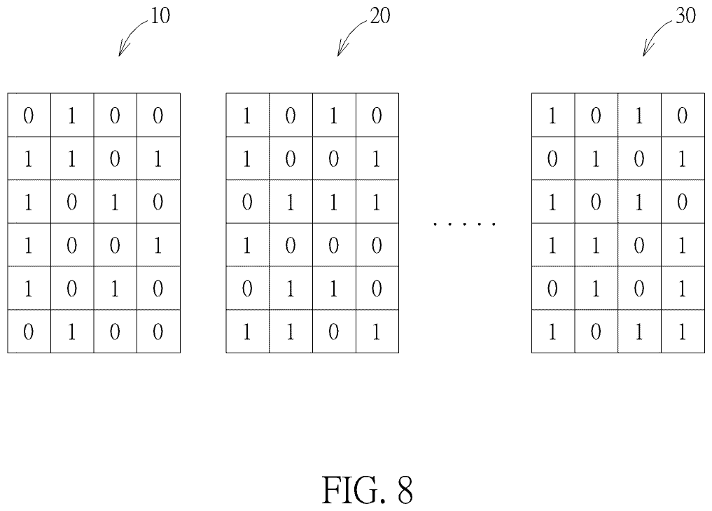

Please refer to FIG. 7, which is a schematic view showing widen resistance distribution of PUF cell in accordance with one embodiment of present invention. Under normal circumstances, as shown in left part of the figure, cell resistance R_{cell} measured from normal PUF cell or structure will be in normal distribution due to process variation and will has a mean value. In the generation of PUF cell random code, the random code of PUF cell having cell resistance R_{cell} less than average may be determined as 0, while the random code of PUF cell having cell resistance R_{cell} greater than average may be determined as 1, so that the PUF cell array composed of multiple PUF cells may produce an innate, inherent electrical fingerprint after its manufacture is completed. As shown in FIG. 8, multiple PUF cell arrays 10, 20, 30 are provided with respective electrical fingerprints composed of random codes 0 and 1.

Although the PUF cells manufactured in the same process may have aforementioned randomness, since the target of semiconductor process always tends to achieve higher stability, uniformity and reduced variability, the range of normal distribution of cell resistance R_{cell} in aforementioned FIG. 7 is not large normally, meaning the randomness of PUF cell is not large. In the present invention, based on the PUF circuit pattern including metal spiral pattern 102 and dummy metal spiral pattern 104 that are specifically designed as shown in aforementioned FIG. 2, the resistance voltage R_{cell} variation measured from PUF cells 100 after applying constant current or voltage is also increased. As the normal distribution shown in right part of FIG. 7, the range of normal distribution curve of cell resistance R_{cell} is wider and has tailing feature. Accordingly, the window for generating and determining the logic level “0” and “1” of random code in PUF application becomes larger, therefore the PUF cells will be less susceptible to read error or distortion resulted from environment change (ex. different operating temperatures lead to the shift of cell resistance R_{cell}), enhancing the reliability and robustness of PUF cells, and the randomness and uniqueness of electrical fingerprint obtained from PUF cell array in the same process may also be increased.

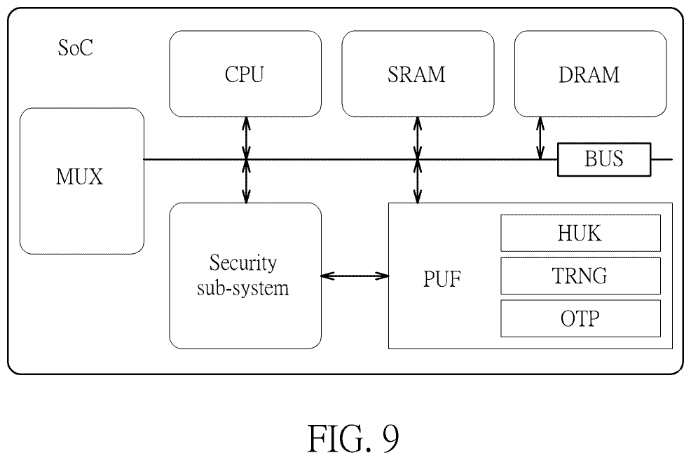

Please refer to FIG. 9, which is a function block diagram of a system-on-a-chip (SoC) with PUF function block in accordance with one embodiment of present invention. The aforementioned PUF cell array 10 of present invention may be used to manufacture the PUF function block in a SoC. As shown in FIG. 9, function blocks like data selector MUX, central processing unit CPU, static random access memory SRAM, dynamic random access memory DRAM, security sub-system and physically unclonable function block PUF may be integrated in the SoC and connected with each other through busbar BUS. The physically unclonable function block PUF may further include sub-blocks like hardware unique key HUK, true random number generator (TRNG) and one-time programmable memory OTP.

In PUF operation, input and output actions are performed by the physically unclonable function block PUF, wherein the input and output matching depend on its PUF attributes. The input of PUF is usually referred as a challenge, while the output is referred as a response. Each set of input may find its similarity through mathematical formula. The purpose of PUF block is to give a challenge value for the same IC, and the acquired response value should be stable and reproducible. With respect to different ICs, response values are different and unique, wherein the hardware unique key HUK therein is the basis to protect every chip, and also a starting point of trust chain in whole system and relevant service, which creates a unique, innate and nonreproducible key. The one-time programmable memory OTP provides options for key storage through the method of anti-fuse memory, wherein conductive path is formed in the monocrystalline oxide layer through quantum tunneling principle, so that no trace may be observed on the surface, which grants them data invisibility. Data selector MUX may select one signal for outputting from multiple analog and digital input signals and be connected to the one-time programmable memory OTP for test actions through busbar BUS. The true random number generator TRNG is provided with digital simulation design, which combines static and dynamic entropies to generate random number through physical process rather than computer program. The physically unclonable function block PUF is connected with the security sub-system to provide safe storage and high-quality entropies for the encryption function in the security sub-system.

In summary of the aforementioned embodiments, the present invention achieves the purpose of enhancing PUF random coding through specific pattern design of metal circuit formed in BEOL process through currently available semiconductor process, which may significantly improve the randomness, uniqueness and robustness required by PUF chips, suitable for the internet of things (IoT) hardware security technology in the zero trust architecture of information security in new generation. In addition, the PUF spiral pattern provided by the present invention may easily adjust target resistance in semiconductor circuit layout, making full use of limited layout area, and the design of input terminal and output terminal respectively at horizontal segment and vertical segment with different orientations may also provide more flexibility and convenience for the routing and design of circuit terminals, which is an invention provided with novelty, non-obviousness and utility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit pattern for physically unclonable function (PUF), comprising a PUF cell array, said PUF cell array is comprised of multiple arranged PUF cells, and each said PUF cell comprises:
a metal spiral pattern, comprising multiple horizontal line segments extending in a horizontal direction connected with multiple vertical line segments extending in a vertical direction and with one end connected to a constant voltage and the other end connected to a ground voltage; and
a dummy metal spiral pattern, comprising multiple dummy horizontal line segments extending in said horizontal direction and multiple dummy vertical line segments extending in said vertical direction and not connected to any voltage, wherein said horizontal line segments and said dummy horizontal line segments are adjacent and alternately arranged in said vertical direction, and said vertical line segments and said dummy vertical line segments are adjacent and alternately arranged in said horizontal direction.

2. The circuit pattern for physically unclonable function (PUF) of claim 1, wherein said constant voltage applied on every said PUF cell and generate a resistance corresponding to said PUF cell, and said resistance is used to determine a random code corresponding to said PUF cell.

3. The circuit pattern for physically unclonable function (PUF) of claim 1, wherein said circuit pattern is a back-end-of-line (BEOL) interconnect.

4. The circuit pattern for physically unclonable function (PUF) of claim 1, wherein said end connected to said constant voltage is at one of said horizontal line segments, and said end connected to said ground voltage is at one of said vertical segments.

5. The circuit pattern for physically unclonable function (PUF) of claim 1, wherein said end connected to said constant voltage is at one of said vertical line segments, and said end connected to said ground voltage is at one of said horizontal segments.

6. A method of achieving physically unclonable function (PUF) through circuit pattern, comprising:
providing a PUF cell array, said PUF cell array is comprised of multiple arranged PUF cells, and each said PUF cell comprises:
a metal spiral pattern, comprising multiple horizontal line segments extending in a horizontal direction connected with multiple vertical line segments extending in a vertical direction and with one end connected to a constant voltage and the other end connected to a ground voltage; and
a dummy metal spiral pattern, comprising multiple dummy horizontal line segments extending in said horizontal direction connected with multiple dummy vertical line segments extending in said vertical direction and not connected to any voltage, wherein said horizontal line segments and said dummy horizontal line segments are adjacent and alternately arranged in said vertical direction, and said vertical line segments and said dummy vertical line segments are adjacent and alternately arranged in said horizontal direction;
applying a constant voltage to said PUF cell array, wherein said constant voltage is applied on every said PUF cell and generates a resistance corresponding to said PUF cell; and
determining a random code of said corresponding PUF cell as 0 if said resistance is less than a setting value, and determining a random code of said corresponding PUF cell as 1 if said resistance is greater than a setting value.

7. The method of achieving physically unclonable function (PUF) through circuit pattern of claim 6, wherein presence of said dummy metal spiral pattern induces pattern variation of adjacent said metal spiral pattern, so that widths of said horizontal line segments and said vertical line segments of said metal spiral pattern are changed, thereby changing said resistance of corresponding said PUF cell.

8. The method of achieving physically unclonable function (PUF) through circuit pattern of claim 6, wherein presence of said dummy metal spiral pattern induces voids formed within said horizontal line segments and said vertical line segments of said metal spiral pattern, thereby changing said resistance of corresponding said PUF cell.

9. The method of achieving physically unclonable function (PUF) through circuit pattern of claim 6, wherein parts of said dummy horizontal line segments or said dummy vertical line segment of said dummy metal spiral pattern are connected with adjacent said horizontal line segments or said vertical line segment of said metal spiral pattern due to overlay shift, thereby changing said resistance of corresponding said PUF cell.

10. The method of achieving physically unclonable function (PUF) through circuit pattern of claim 6, wherein said metal spiral pattern and said dummy metal spiral pattern are formed through litho-etch-litho-etch (LELE) process.
